(19) United States
(12) Patent Application Publication
(10) Pub. No.: US 2026/0254467 A1
(43) Pub. Date: Aug. 27, 2026

(54) RADIO FREQUENCY COMMUNICATION SYSTEM, DEVICE AND METHOD

(71) Applicants: Beijing BOE Technology Development Co., Ltd., Beijing (CN); BOE Technology Group Co., Ltd., Beijing (CN)

(72) Inventors: Xichao FAN, Beijing (CN); Zhipeng LU, Beijing (CN); Yali WANG, Beijing (CN); Biqi LI, Beijing (CN)

(21) Appl. No.: 18/992,169

(22) PCT Filed: Apr. 17, 2024
(86) PCT No.: PCT/CN2024/088341

§ 371 Date: Jan. 7, 2025

(30) Foreign Application Priority Data
May 30, 2023 (CN) 202310628976.2

(51) Int. Cl. H04B 1/00

(52) U.S. Cl. CPC H04B 1/0096; H04B 1/0032; H04B 1/006

(57) ABSTRACT

Disclosed are a radio frequency communication system, an apparatus and a method. The radio frequency communication system includes a first link, a second link, and a transceiver device, where: the first link is configured to receive a radio frequency signal in a satellite communication frequency band, perform a first signal processing on the radio frequency signal to obtain a first signal, and transmit the first signal to the transceiver device; the transceiver device is configured to perform a frequency conversion on a frequency of the first signal once to convert the frequency of the first signal into a frequency band of a baseband signal, and transmit a frequency converted first signal to the second link; and the second link is configured to perform a second signal processing on the frequency converted first signal to obtain a second signal, and transmit the second signal.

### CROSS-REFERENCE OF RELATED APPLICATIONS

The present application is a national phase entry under 35 U.S.C. § 371 of International Application No. PCT/CN2024/088341, filed on Apr. 17, 2024, which claims priority to Chinese Patent Application No. 202310628976.2, filed with the China National Intellectual Property Administration on May 30, 2023 and entitled “Radio Frequency Communication System, Apparatus and Method”, which is hereby incorporated by reference in its entirety.

### TECHNICAL FIELD

The present disclosure relates to the field of satellite communication technology, and in particular to a radio frequency communication system, an apparatus and a method.

### BACKGROUND

With the rapid development of modern land mobile communication, human demand for mobile communication is also increasing. As a supplement to ground cellular mobile communication systems, satellite mobile communication systems can better leverage their advantages in areas where building ground networks is very difficult. The satellite mobile communication system is a product of the cross combination of traditional fixed satellite communication and mobile communication. It is both a satellite communication system that provides mobile services and a mobile communication system that uses satellites as relay stations.

According to the orbit used by the system, it can be divided into GEO (Geostationary Orbit), LEO (Low Earth Orbit), MEO (Medium Earth Orbit), and HEO (High Earth Orbit) satellite mobile communication systems. The low earth orbit satellite communication frequency band mainly operates in the C, Ka, Ku and other frequency bands, requiring the transmitter and receiver to have small size, low power consumption and extremely high performance level. However, the current transmitter and receiver cannot meet the design requirements.

### SUMMARY

The present disclosure provide a radio frequency communication system, an apparatus and a method for reducing the radio frequency signal of satellite communication frequency band to the frequency range of baseband signal through one single frequency conversion, meeting the requirements of small size, low power consumption, and high performance of low orbit satellites.

In one aspect, embodiments of the present disclosure provide a radio frequency communication system, including: a first link, a second link, and a transceiver device, where:
the first link is configured to receive a radio frequency signal in a satellite communication frequency band, perform a first signal processing on the radio frequency signal to obtain a first signal, and transmit the first signal to the transceiver device;
the transceiver device is configured to perform a frequency conversion on a frequency of the first signal once to convert the frequency of the first signal into a frequency band of a baseband signal, and transmit a frequency converted first signal to the second link; and
the second link is configured to perform a second signal processing on the frequency converted first signal to obtain a second signal, and transmit the second signal.

In some embodiments, the first link includes a first antenna, a first radio frequency switch, a low noise power amplifier, a first mixer and a first filter; where the first link is further configured to:
receive the radio frequency signal using the first antenna; and
perform the first signal processing on the radio frequency signal using the first radio frequency switch, the low noise power amplifier, the first mixer and the first filter to obtain the first signal.

In some embodiments, the first filter includes a first sub-filter, a second sub-filter and a third sub-filter, and the low noise power amplifier includes a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, the second link includes a second antenna, a second radio frequency switch, a power amplifier, a second mixer, and a second filter; where the second link is further configured to:
perform the second signal processing on the frequency converted first signal using the second radio frequency switch, the power amplifier, the second mixer and the second filter to obtain the second signal; and
transmit the second signal using the second antenna.

In some embodiments, the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the first link and the second link are connected with the same radio frequency switch or the same circulator for compatibility with time division duplex mode.

In some embodiments, the first link includes a first radio frequency switch; and the second link includes a second radio frequency switch;
where the first radio frequency switch and the second radio frequency switch are arranged as a circulator.

In some embodiments, the transceiver device is further configured to:
perform a frequency mixing processing on the first signal to obtain a frequency mixed first signal;
perform an analog-to-digital conversion processing on the frequency mixed first signal to obtain an analog-to-digital conversed first signal;
perform an orthogonal modulation calibration processing on the analog-to-digital conversed first signal to obtain a calibrated first signal; and
perform a filtering processing on the calibrated first signal to obtain the frequency converted first signal.

In some embodiments, the transceiver device is further configured to:
receive the baseband signal;
perform a filtering processing on the baseband signal to obtain a filtered baseband signal;
perform an analog-to-digital conversion processing on the filtered baseband signal to obtain an analog-to-digital conversed baseband signal, and
perform a frequency mixing processing on the analog-to-digital conversed baseband signal to obtain a first radio frequency signal.

In some embodiments, the transceiver device is further configured to:
perform an analog-to-digital conversion processing on the first signal to obtain an analog-to-digital conversed first signal;
perform a threshold detection processing on the analog-to-digital conversed first signal to obtain a threshold detected first signal;
perform an orthogonal modulation calibration processing on the threshold detected first signal to obtain a calibrated first signal;
perform a frequency mixing processing on the calibrated first signal to obtain a frequency mixed first signal; and
perform a demodulation processing on the frequency mixed first signal to obtain the frequency converted first signal.

In some embodiments, the transceiver device is further configured to:
receive the baseband signal;
perform a modulate processing on the baseband signal to obtain a modulated baseband signal;
perform a frequency mixing processing on the modulated baseband signal to obtain a frequency mixed baseband signal;
perform an orthogonal modulation calibration processing on the frequency mixed baseband signal to obtain a calibrated baseband signal; and
perform an analog-to-digital conversion processing on the calibrated baseband signal to obtain a second radio frequency signal.

In a second aspect, embodiments of the present disclosure provide a radio frequency communication apparatus, including a processor and a memory, where the memory stores program codes, and the program codes, when executed by the processer, cause the processor to perform the process of:
receiving a radio frequency signal in a satellite communication frequency band, and performing a first signal processing on the radio frequency signal to obtain a first signal;
performing a frequency conversion on a frequency of the first signal once to convert the frequency of the first signal into a frequency band of a baseband signal; and
performing a second signal processing on the frequency converted first signal to obtain a second signal, and transmitting the second signal.

In some embodiments, the processor is further configured to perform:
receiving the radio frequency signal using a first antenna; and
performing the first signal processing on the radio frequency signal using a first radio frequency switch, a low noise power amplifier, a first mixer and a first filter to obtain the first signal.

In some embodiments, the first filter includes a first sub-filter, a second sub-filter and a third sub-filter, and the low noise power amplifier includes a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, the processor is further configured to perform:
performing the second signal processing on the frequency converted first signal using a second radio frequency switch, a power amplifier, a second mixer and a second filter to obtain the second signal; and
transmitting the second signal using a second antenna.

In some embodiments, the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the first radio frequency switch and the second radio frequency switch are arranged as a circulator.

In some embodiments, the processor is further configured to perform:
performing a frequency mixing processing on the first signal;
performing an analog-to-digital conversion processing on a frequency mixed first signal;
performing an orthogonal modulation calibration processing on an analog-to-digital conversed first signal; and
performing a filtering processing on a calibrated first signal to obtain the frequency converted first signal.

In some embodiments, the processor is further configured to perform:
receiving the baseband signal;
performing a filtering processing on the baseband signal;
performing an analog-to-digital conversion processing on a filtered baseband signal, and
performing a frequency mixing processing on an analog-to-digital conversed baseband signal to obtain a first radio frequency signal.

In some embodiments, the processor is further configured to perform:
performing an analog-to-digital conversion processing on the first signal;
performing a threshold detection processing on an analog-to-digital conversed first signal;
performing an orthogonal modulation calibration processing on a threshold detected first signal;
performing a frequency mixing processing on a calibrated first signal; and
performing a demodulation processing on a frequency mixed first signal to obtain the frequency converted first signal.

In some embodiments, the processor is further configured to perform:
receiving the baseband signal;
performing a modulate processing on the baseband signal;
performing a frequency mixing processing on a modulated baseband signal;
performing an orthogonal modulation calibration processing on a frequency mixed baseband signal; and
performing an analog-to-digital conversion processing on a calibrated baseband signal to obtain a second radio frequency signal.

In a third aspect, embodiments of the present disclosure provide a radio frequency communication method, including:
receiving a radio frequency signal in a satellite communication frequency band, and performing a first signal processing on the radio frequency signal to obtain a first signal;
performing a frequency conversion on a frequency of the first signal once to convert the frequency of the first signal into a frequency band of a baseband signal; and
performing a second signal processing on the frequency converted first signal to obtain a second signal, and transmitting the second signal.

In some embodiments, the receiving a radio frequency signal in a satellite communication frequency band, and performing a first signal processing on the radio frequency signal to obtain a first signal, includes:
receiving the radio frequency signal using a first antenna; and
performing the first signal processing on the radio frequency signal using a first radio frequency switch, a low noise power amplifier, a first mixer and a first filter to obtain the first signal.

In some embodiments, the first filter includes a first sub-filter, a second sub-filter and a third sub-filter, and the low noise power amplifier includes a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, the performing a second signal processing on the frequency converted first signal to obtain a second signal, includes:
performing the second signal processing on the frequency converted first signal using a second radio frequency switch, a power amplifier, a second mixer and a second filter to obtain the second signal; and
transmitting the second signal using a second antenna.

In some embodiments, the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the method further includes: arranging the first radio frequency switch and the second radio frequency switch as a circulator.

In some embodiments, the performing a first signal processing on the radio frequency signal, includes:
performing a frequency mixing processing on the first signal;
performing an analog-to-digital conversion processing on a frequency mixed first signal;
performing an orthogonal modulation calibration processing on an analog-to-digital conversed first signal; and
performing a filtering processing on a calibrated first signal to obtain the frequency converted first signal.

In some embodiments, the method further includes:
receiving the baseband signal;
performing a filtering processing on the baseband signal;
performing an analog-to-digital conversion processing on a filtered baseband signal, and
performing a frequency mixing processing on an analog-to-digital conversed baseband signal to obtain a first radio frequency signal.

In some embodiments, the performing a first signal processing on the radio frequency signal, includes:
performing an analog-to-digital conversion processing on the first signal;
performing a threshold detection processing on an analog-to-digital conversed first signal;
performing an orthogonal modulation calibration processing on a threshold detected first signal;
performing a frequency mixing processing on a calibrated first signal; and
performing a demodulation processing on a frequency mixed first signal to obtain the frequency converted first signal.

In some embodiments, the method further includes:
receiving the baseband signal;
performing a modulate processing on the baseband signal;
performing a frequency mixing processing on a modulated baseband signal;
performing an orthogonal modulation calibration processing on a frequency mixed baseband signal; and
performing an analog-to-digital conversion processing on a calibrated baseband signal to obtain a second radio frequency signal.

In the fourth aspect, embodiments of the present disclosure provide a radio frequency communication apparatus, including:
a receiving module, configured to receive a radio frequency signal in a satellite communication frequency band, and performing a first signal processing on the radio frequency signal to obtain a first signal;
a frequency conversion module, configured to perform a frequency conversion on a frequency of the first signal once to convert the frequency of the first signal into a frequency band of a baseband signal; and
a transmitting module, configured to perform a second signal processing on the frequency converted first signal to obtain a second signal, and transmitting the second signal.

In some embodiments, the receiving module is further configured to:
receive the radio frequency signal using a first antenna; and
perform the first signal processing on the radio frequency signal using a first radio frequency switch, a low noise power amplifier, a first mixer and a first filter to obtain the first signal.

In some embodiments, the first filter includes a first sub-filter, a second sub-filter and a third sub-filter, and the low noise power amplifier includes a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, the transmitting module is further configured to:
perform the second signal processing on the frequency converted first signal using a second radio frequency switch, a power amplifier, a second mixer and a second filter to obtain the second signal; and
transmit the second signal using a second antenna.

In some embodiments, the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the apparatus further includes an arranging module configured to arrange the first radio frequency switch and the second radio frequency switch as a circulator.

In some embodiments, the receiving module is further configured to:
perform a frequency mixing processing on the first signal;
perform an analog-to-digital conversion processing on a frequency mixed first signal;
perform an orthogonal modulation calibration processing on an analog-to-digital conversed first signal; and
perform a filtering processing on a calibrated first signal to obtain the frequency converted first signal.

In some embodiments, the receiving module is further configured to:
receive the baseband signal;
perform a filtering processing on the baseband signal;
perform an analog-to-digital conversion processing on a filtered baseband signal, and
perform a frequency mixing processing on an analog-to-digital conversed baseband signal to obtain a first radio frequency signal.

In some embodiments, the receiving module is further configured to:
perform an analog-to-digital conversion processing on the first signal;
perform a threshold detection processing on an analog-to-digital conversed first signal;
perform an orthogonal modulation calibration processing on a threshold detected first signal;
perform a frequency mixing processing on a calibrated first signal; and
perform a demodulation processing on a frequency mixed first signal to obtain the frequency converted first signal.

In some embodiments, the receiving module is further configured to:
receive the baseband signal;
perform a modulate processing on the baseband signal;
perform a frequency mixing processing on a modulated baseband signal;
perform an orthogonal modulation calibration processing on a frequency mixed baseband signal; and
perform an analog-to-digital conversion processing on a calibrated baseband signal to obtain a second radio frequency signal.

In a fifth aspect, embodiments of the present disclosure provide a computer storage medium storing a computer program thereon, where the program, when executed by a processor, implements the method in the above third aspect.

The aspects or other aspects disclosed herein will be more concise and understandable in the description of the following embodiments.

### BRIEF DESCRIPTION OF FIGURES

In order to more clearly illustrate the technical solutions in embodiments of the present disclosure, a brief introduction will be given below to the drawings needed to be used in the description of embodiments. Obviously, the drawings in the following description are only some embodiments of the present disclosure. Those of ordinary skill in the art can also obtain other drawings based on these drawings without exerting creative efforts.

FIG. 1 shows a flowchart of communication architecture for signal transmitting and receiving provided by embodiments of the present disclosure.

FIG. 2 shows a schematic diagram of a radio frequency communication system provided by embodiments of the present disclosure.

FIGS. 3A to 3B show schematic diagrams of the radio frequency system provided by embodiments of the present disclosure.

FIGS. 4A to 4B show schematic diagrams of the improved radio frequency communication system provided by embodiments of the present disclosure.

FIGS. 5A to 5B show schematic diagrams of the improved radio frequency system provided by embodiments of the present disclosure.

FIG. 6 shows a schematic diagram of a composition of a radio frequency front-end provided by embodiments of the present disclosure.

FIG. 7 shows a receiving flow diagram of a radio frequency front-end provided by embodiments of the present disclosure.

FIG. 8 shows a transmitting flow diagram of a radio frequency front-end provided by an embodiment of the present disclosure.

FIG. 9 shows a receiving flow diagram of a radio frequency front-end provided by an embodiment of the present disclosure.

FIG. 10 shows a transmitting flow diagram of a radio frequency front-end provided by an embodiment of the present disclosure.

FIG. 11 shows a schematic diagram of an internal alignment of an FPGA provided by embodiments of the present disclosure.

FIG. 12 shows a schematic diagram of internal integration of an RFSoC provided by embodiments of the present disclosure.

FIG. 13 shows a diagram of a three-stage super-heterodyne mode radio frequency system provided by embodiments of the present disclosure.

FIG. 14 shows a schematic diagram of a radio frequency communication apparatus provided by embodiments of the present disclosure.

FIG. 15 shows a flowchart of a radio frequency communication method provided by embodiments of the present disclosure.

FIG. 16 shows a schematic diagram of a radio frequency communication apparatus provided by embodiments of the present disclosure.

### DETAILED DESCRIPTION

In order to make the purpose, technical solutions and advantages of the present disclosure clearer, the following will be combined with the accompanying drawings to further describe the present disclosure in detail, it is clear that the described embodiments are only a part of the present disclosure of embodiments, not all of embodiments. Based on embodiments of the present disclosure, all other embodiments obtained by a person of ordinary skill in the art without making creative labor are within the scope of protection of the present disclosure.

The term “and/or” in embodiments of the present disclosure describes an association relationship of an associated object, indicating that three relationships may exist, for example, A and/or B, which may be expressed as A alone, both A and B, and B alone. The character “/” generally indicates an “or” relationship between the objects associated before and after.

The application scenarios described in embodiments of the present disclosure are for the purpose of more clearly illustrating the technical solutions of embodiments of the present disclosure, and do not constitute a limitation of the technical solutions provided by embodiments of the present disclosure, and a person of ordinary skill in the art may know that, with the emergence of new application scenarios, the technical solutions provided by embodiments of the present disclosure are equally applicable to similar technical problems. In the description of the present disclosure, unless otherwise specified, “more than one” means two or more.

With the rapid development of modern land mobile communication, human demand for mobile communication is also increasing. As a supplement to ground cellular mobile communication systems, satellite mobile communication systems can better leverage their advantages in areas where building ground networks is very difficult. The satellite mobile communication system is a product of the cross combination of traditional fixed satellite communication and mobile communication. It is both a satellite communication system that provides mobile services and a mobile communication system that uses satellites as relay stations.

According to the orbit used by the system, it can be divided into GEO (Geostationary Orbit), LEO (Low Earth Orbit), MEO (Medium Earth Orbit), and HEO (High Earth Orbit) satellite mobile communication systems. The low earth orbit satellite communication industry belongs to the sub industry of satellite applications, including the construction and operation of the industrial chain space segment, the construction and operation of the ground segment, and the terminal market. Specifically, it includes satellite/rocket parts and components manufacturing, satellite/rocket research and development, satellite launch services, ground network equipment manufacturing, satellite operation, terminal equipment manufacturing, applications and services, and other links.

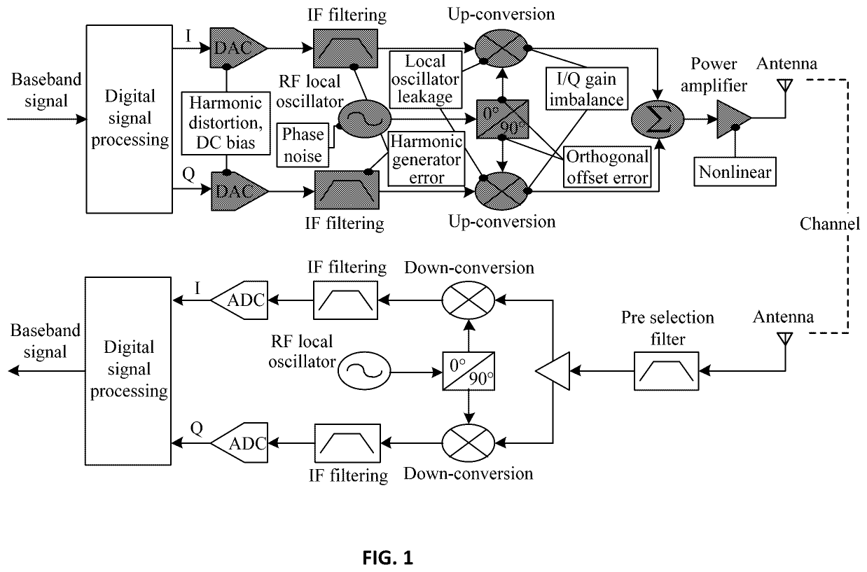

Currently, there are three types of transmitter-receiver solutions: 1) heterodyne receiver; 2) direct sampling receiver; 3) direct frequency conversion receiver. Only for the satellite platform, direct sampling receiver and direct frequency conversion receiver program is not feasible, while the power consumption of the heterodyne receiver is too large. As shown in FIG. 1, embodiments provide a signal transceiver communication architecture flowchart, the baseband signal on the transmitting link is processed by digital signal processing, DAC conversion, filtering, frequency conversion, etc., and then transmitted by the antenna through a power amplifier; the signal received by the antenna on the receiving link is converted into a baseband signal after the filtering, low-noise power amplifier, frequency conversion, filtering, and ADC conversion.

Low earth orbit satellite communication bands mainly work in the C, Ka, Ku and other frequency bands, which require the transmitter-receiver to have a small size, low power consumption and very high performance level, but the current transmitter-receiver cannot meet the design requirements.

Embodiments of the present disclosure provide a radio frequency communication system capable of converting a radio frequency signal into a frequency band of a baseband signal by one-time frequency conversion, thereby realizing one-stage frequency conversion, and lowering a radio frequency signal in a satellite communication frequency band to a frequency band range of a baseband signal by one-time frequency conversion, so as to satisfy the requirements of a low earth orbit satellite in terms of small size, low-power consumption, and high performance.

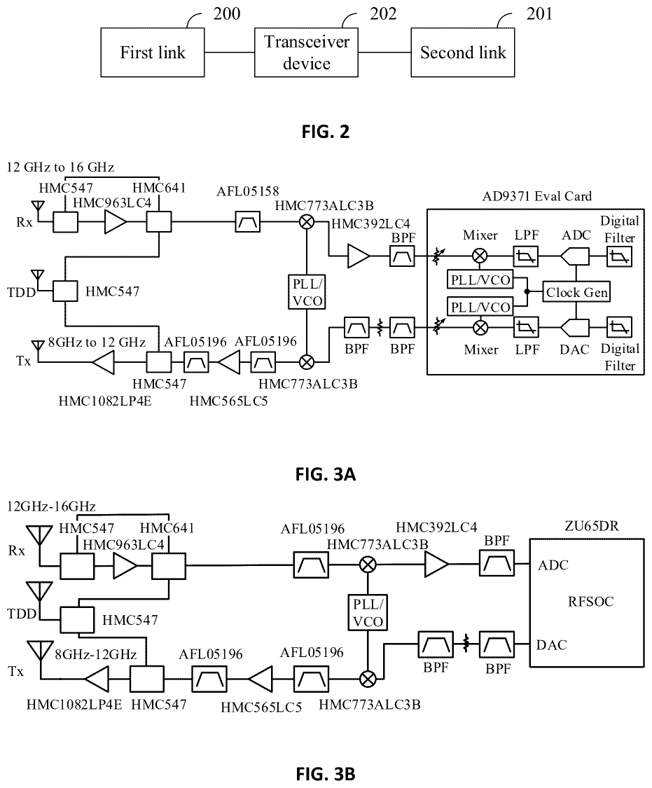

As shown in FIG. 2, the present embodiment provides a radio frequency communication system including a first link 200, a second link 201, and a transceiver device 202, where:
the first link 200 is configured to receive a radio frequency signal in a satellite communication frequency band, perform a first signal processing on the radio frequency signal to obtain a first signal, and transmit the first signal to the transceiver device;
the transceiver device 202 is configured to perform a frequency conversion on a frequency of the first signal once to convert the frequency of the first signal into a frequency band of a baseband signal, and transmit a frequency converted first signal to the second link; and
the second link 201 is configured to perform a second signal processing on the frequency converted first signal to obtain a second signal, and transmit the second signal.

In some embodiments, the transceiver device in the embodiment includes an AD9371 or a ZU65DR.

In some embodiments, the first link 200 includes a first antenna, a first radio frequency switch, a low noise power amplifier, a first mixer and a first filter; where the first link 200 is further configured to:
receive the radio frequency signal using the first antenna; and
perform the first signal processing on the radio frequency signal using the first radio frequency switch, the low noise power amplifier, the first mixer and the first filter to obtain the first signal.

In some embodiments, the second link 201 includes a second antenna, a second radio frequency switch, a power amplifier, a second mixer, and a second filter; where the second link is further configured to:
perform the second signal processing on the frequency converted first signal using the second radio frequency switch, the power amplifier, the second mixer and the second filter to obtain the second signal; and
transmit the second signal using the second antenna.

In some embodiments, the first link is a receiving Rx link, and the second link is a transmitting Tx link, as shown in FIGS. 3A to 3B, embodiments provide schematic diagrams of a radio frequency system. As shown in FIG. 3A, taking AD9371 as an example, the Rx link includes a first antenna, a first radio frequency switch (such as HMC547/HMC641), a low-noise power amplifier LNA (such as HMC963LC4/HMC392LC4), a first mixer (such as HMC773ALC3B), a first filter (such as BPF/AFL05158), and other devices. The Tx link includes a power amplifier (such as HMC1082LP4E), a second radio frequency switch (such as HMC547), a second filter (such as BPF/AFL05196), a second mixer (such as HMC773ALC3B), an adjustable attenuator, etc. Rx, Tx, and AD9371 form a high to medium frequency architecture KU RF system, which achieves a first level frequency conversion from the 12 to 16GHz KA frequency band to the 300M to 6GHz frequency band, reducing the frequency reduction of second level mixing. The scheme is a zero intermediate frequency scheme. In fact, the AD9371 still presents a chip with greatly reduced power consumption and size, despite the integration of first level mixing internally. The single channel achieves a 100 MHz RF bandwidth, which is wider and faster than the 36 MHz of super-heterodyne.

As shown in FIG. 3B, the present embodiments provide a schematic diagram of a radio frequency system, taking a ZU65DR as an example, the Rx link includes a first antenna, a first radio frequency switch (e.g., HMC547/HMC641), a low-noise power amplifier LNA (e.g., HMC963LC4/HMC392LC4), a first mixer (e.g., HMC773ALC3B), and a first filter (e.g., a BPF/AFL05158) and other devices. Tx link includes power amplifier (e.g., HMC1082LP4E), the second radio frequency switch (e.g., HMC547), the second filter (e.g., BPF/AFL05196), the second mixer (e.g., HMC773ALC3B), and adjustable attenuator, etc. The Rx, Tx, and the ZU65DR form a high and medium frequency architecture KU RF system, which achieves a first level frequency conversion from the 12 to 16GHz KA frequency band to the 300M to 7.5GHz frequency band, reducing the frequency reduction of second level mixing. ZU65DR and AD9371 are different, ZU65DR is a direct sampling scheme, there is no internal frequency conversion phase-locked loop, but the performance can still be satisfied with the use. The single channel radio frequency bandwidth reaches 400 MHz, which is wider and faster than the 36 MHz of the super-heterodyne.

In some embodiments, the present embodiment can improve the current Tx and Rx links, and the improvements to the first link (Rx link) are as follows:
the first filter includes a first sub-filter, a second sub-filter and a third sub-filter, and the low noise power amplifier comprises a first low noise power amplifier and a second low noise power amplifier.
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, and the improvements to the second link (Tx link) are as follows:
the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the redundant filters and fixed attenuators can be eliminated, the position of the radio frequency switch can be placed after the power amplifier. Due to the fact that the withstand power of the radio frequency switch HMC547 is only 1W, the radio frequency switch can be changed to a high-power, low insertion loss device to be compatible with TDD mode.

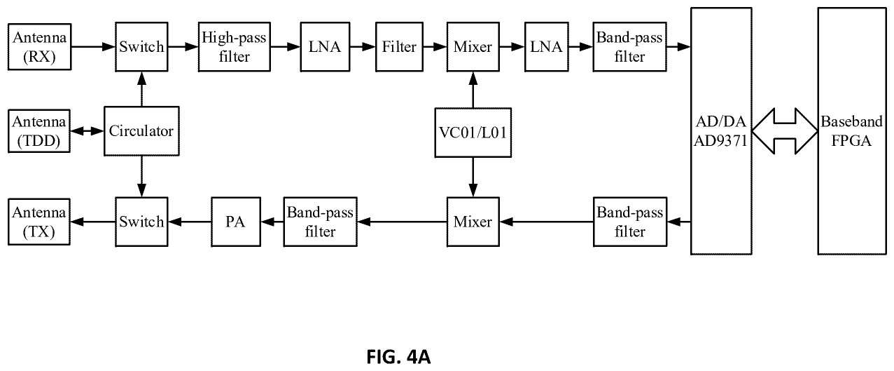

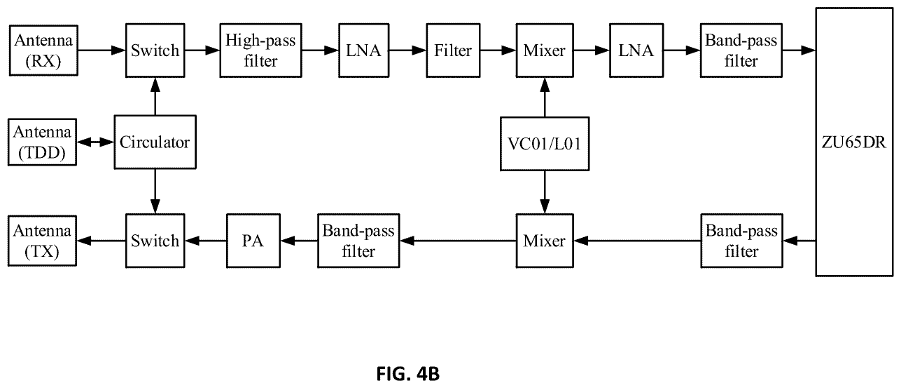

As shown in FIGS. 4A to 4B, embodiments provide a schematic diagram of an improved radio frequency communication system, taking an AD9371 or a ZU65DR as an example, where a first link (Rx link) includes: an antenna, a switch (a first radio frequency switch), a first filter including a first sub-filter (a high-pass filter), a second sub-filter (a filter), and a third sub-filter (a BPF band-pass filter), LNA (first low noise power amplifier) and LNA (second low noise power amplifier), and a mixer (first mixer). The second link (Tx link) includes: an antenna, a switch (second radio frequency switch), a power amplifier (PA), the second filter including a fourth sub-filter (BPF band-pass filter) and a fifth sub-filter (BPF band-pass filter), a mixer (second mixer).

In some embodiments, taking ZU65DR as an example, firstly, check the reference material of RFSoC ZU65DR. The input and output power of ADC/DAC of ZU65DR is not significantly different from the input and output power of ADC/DAC of AD9371, and they are basically the same on small signals. Therefore, ZU65DR can refer to the optimization scheme of AD9371 for reference.

In some embodiments, the first link and the second link are connected with the same radio frequency switch or circulator for compatibility with time division duplex mode (TDD mode).

In some embodiments, embodiments can also continue to be optimized on the improved scheme of FIGS. 4A to 4B by using a circulator instead of the radio frequency switch, and the circulator has a relatively large power tolerance and a lower cost, and the circulator works as follows: A port enters, B port exits, B port enters, and C port exits. There is a relatively large isolation between C and A, which can be used to achieve TDD mode and further save costs.

Optionally, the first link includes a first radio frequency switch and the second link includes a second radio frequency switch; the radio frequency further includes: arranging the first radio frequency switch and the second radio frequency switch as a circulator.

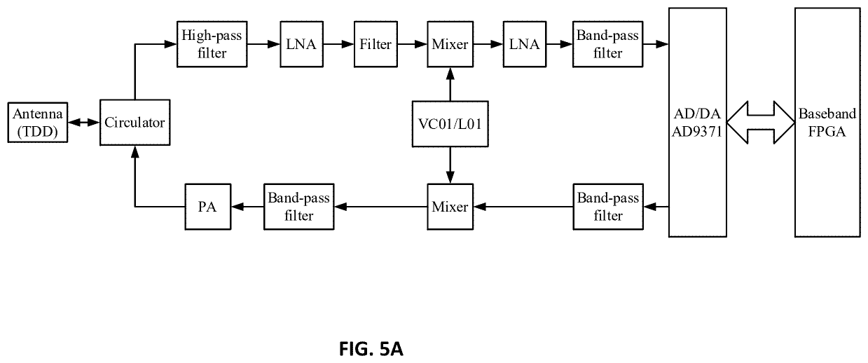

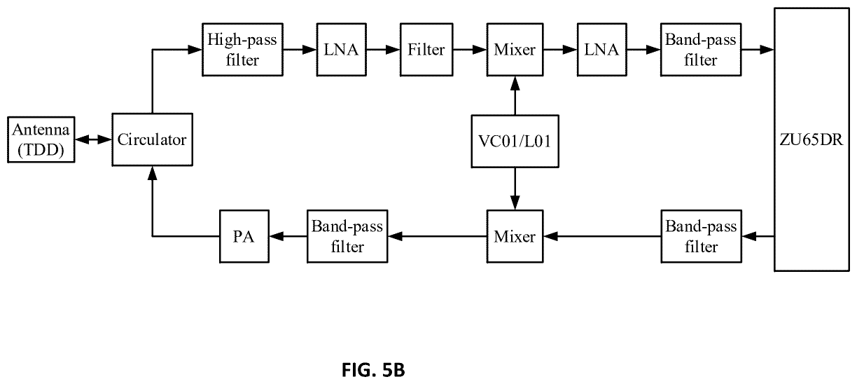

As shown in FIGS. 5A to 5B, embodiments of the present disclosure provide the schematic diagrams of an improved radio frequency system, taking AD9371 or ZU65DR as an example. The first link (Rx link) includes an antenna, a circulator, a first filter including a first sub-filter (high-pass filter), a second sub-filter (filter), and a third sub-filter (BPF band-pass filter), LNA (first low-noise power amplifier) and LNA (second low-noise power amplifier), and a mixer (first mixer). The second link (Tx link) includes an antenna, a circulator, a power amplifier (PA), the second filter including a fourth sub-filter (BPF band-pass filter) and a fifth sub-filter (BPF band-pass filter), and a mixer (second mixer).

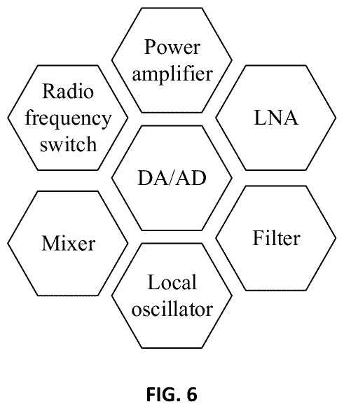

In some embodiments, as shown in FIG. 6, the main components of the radio frequency front-end include: a power amplifier, a radio frequency switch, LNA, a mixer, a local oscillator, AD/DA conversion and a filter. The working principle of the radio frequency system in the embodiment is as follows: the antenna receives the signal, which is then lowered to the C-band or L-band by the radio frequency front-end; the data is collected and organized using AD/DA, and then handed over to the algorithm for modulation, demodulation, and encoding/decoding. The obtained information is the source code, which is grouped and transmitted to the core network for user use.

In some embodiments, the transceiver device is specifically configured to: perform a frequency mixing processing on the first signal; perform an analog-to-digital conversion processing on a frequency mixed first signal; perform an orthogonal modulation calibration processing on an analog-to-digital conversed first signal; and perform a filtering processing on a calibrated first signal to obtain the frequency converted first signal.

In some embodiments, the transceiver device is specifically further configured to: receive the baseband signal; perform a filtering processing on the baseband signal; perform an analog-to-digital conversion processing on a filtered baseband signal, and perform a frequency mixing processing on an analog-to-digital conversed baseband signal to obtain a first radio frequency signal.

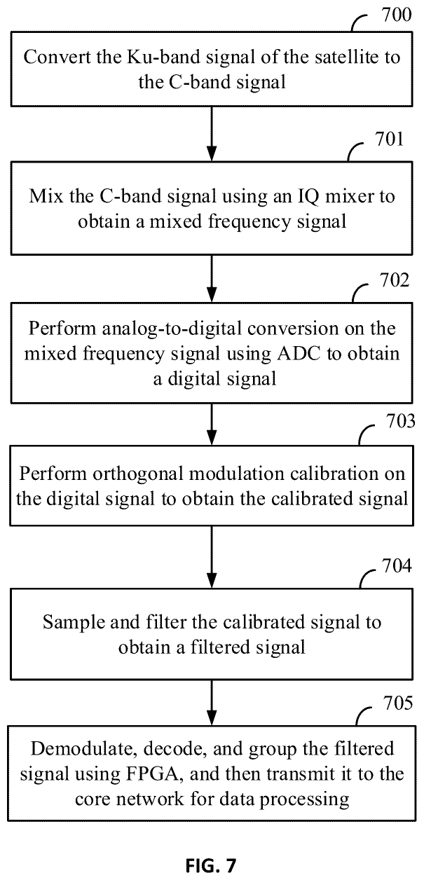

As shown in FIG. 7, the present embodiment also provides a receiving workflow of a radio frequency front-end, taking AD9371 as an example, as follows.

Step 700: convert the Ku-band signal of the satellite to the C-band signal.

Step 701: mix the C-band signal using an IQ mixer to obtain a mixed frequency signal.

Step 702: perform analog-to-digital conversion on the mixed frequency signal using ADC to obtain a digital signal.

Step 703: perform orthogonal modulation calibration on the digital signal to obtain the calibrated signal.

Step 704: sample and filter the calibrated signal to obtain a filtered signal.

Steps 701 to 704 are implemented by AD9371.

Step 705: demodulate, decode, and group the filtered signal using FPGA, and then transmit it to the core network for data processing.

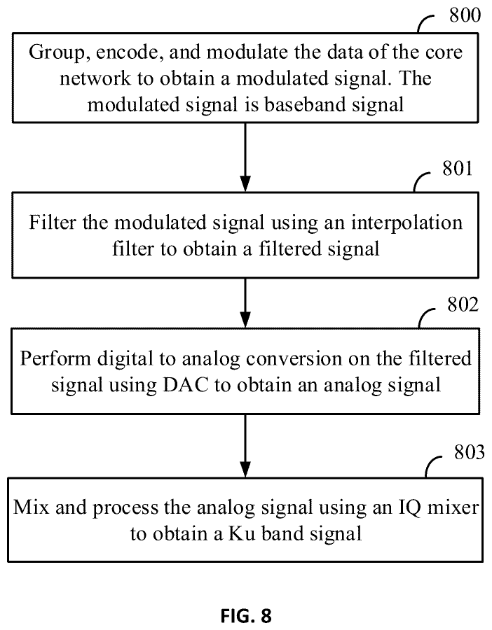

As shown in FIG. 8, the present embodiment also provides a radio frequency front-end transmitting workflow, taking the AD9371 as an example, as follows.

Step 800: group, encode, and modulate the data of the core network to obtain a modulated signal. The modulated signal is baseband signal.

Step 801: filter the modulated signal using an interpolation filter to obtain a filtered signal.

Step 802: perform digital to analog conversion on the filtered signal using DAC to obtain an analog signal.

Step 803: mix and process the analog signal using an IQ mixer to obtain a Ku band signal.

Steps 801 to 803 are implemented by AD9371.

In some embodiments, the transceiver device is specifically configured to: perform an analog-to-digital conversion processing on the first signal; perform a threshold detection processing on an analog-to-digital conversed first signal; perform an orthogonal modulation calibration processing on a threshold detected first signal; perform a frequency mixing processing on a calibrated first signal; and perform a demodulation processing on a frequency mixed first signal to obtain the frequency converted first signal.

In some embodiments, the transceiver device is specifically further configured to: receive the baseband signal; perform a modulate processing on the baseband signal; perform a frequency mixing processing on a modulated baseband signal; perform an orthogonal modulation calibration processing on a frequency mixed baseband signal; and perform an analog-to-digital conversion processing on a calibrated baseband signal to obtain a second radio frequency signal.

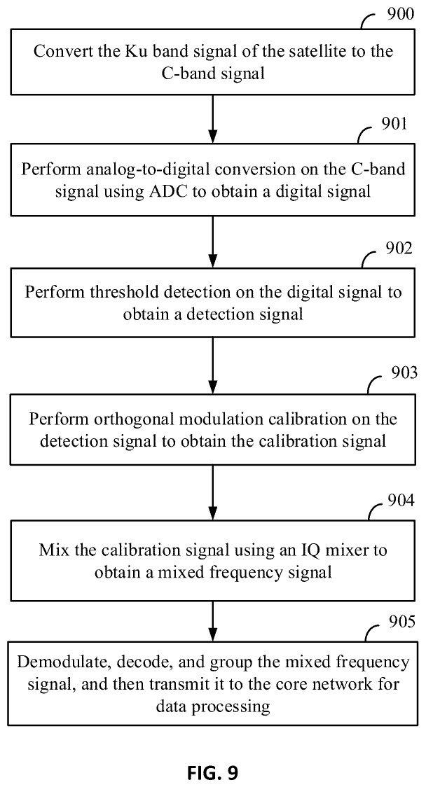

As shown in FIG. 9, the present embodiment also provides a receiving workflow of a radio frequency front-end, taking ZU65DR as an example, as follows.

Step 900: convert the Ku band signal of the satellite to the C-band signal.

Step 901: perform analog-to-digital conversion on the C-band signal using ADC to obtain a digital signal.

Step 902: perform threshold detection on the digital signal to obtain a detection signal.

Step 903: perform orthogonal modulation calibration on the detection signal to obtain the calibration signal.

Step 904: mix the calibration signal using an IQ mixer to obtain a mixed frequency signal.

Step 905: demodulate, decode, and group the mixed frequency signal, and then transmit it to the core network for data processing.

Among them, steps 901-905 are implemented by ZU65DR.

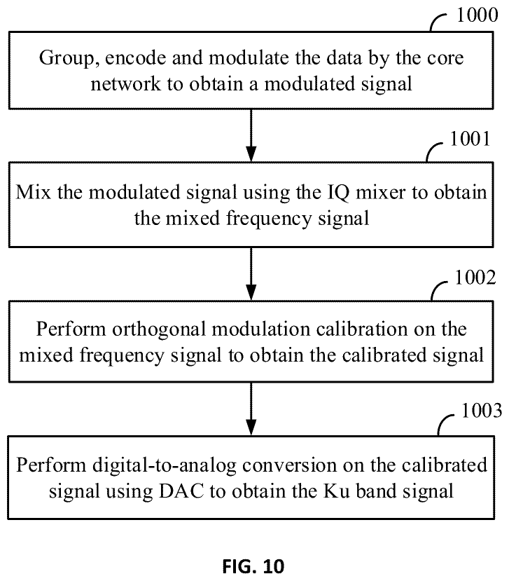

As shown in FIG. 10, the present embodiment also provides a transmitting workflow of a radio frequency front-end, taking ZU65DR as an example, as follows.

Step 1000: group, encode and modulate the data by the core network to obtain a modulated signal.

Step 1001: mix the modulated signal using the IQ mixer to obtain the mixed frequency signal.

Step 1002: perform orthogonal modulation calibration on the mixed frequency signal to obtain the calibrated signal.

Step 1003: perform digital-to-analog conversion on the calibrated signal using DAC to obtain the Ku band signal.

Steps 1000-1003 are implemented by ZU65DR.

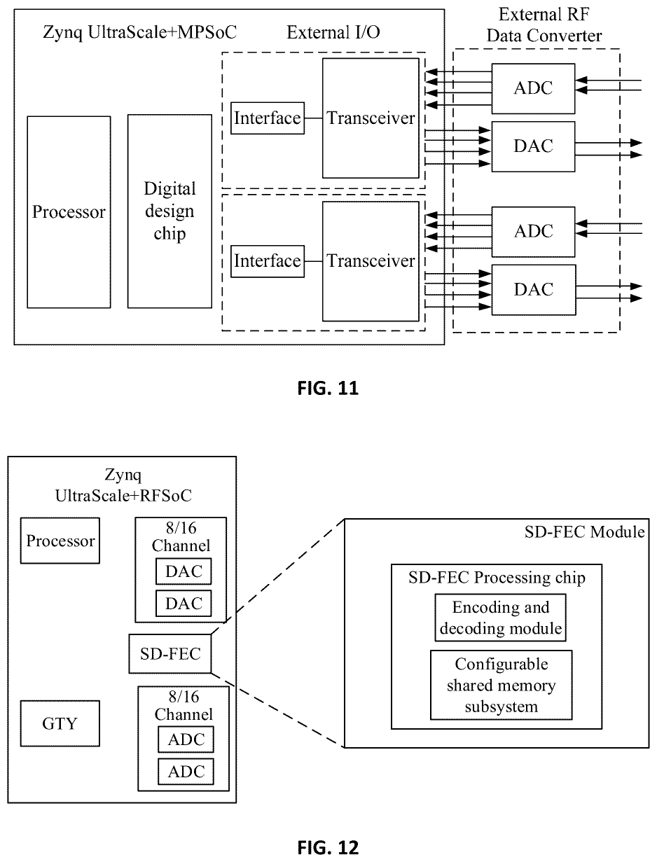

In some embodiments, RFSoC uses direct sampling technology for RF reception and transmission. This technology is relatively complex, integrating FPGA and RF small signal parts together. The power consumption of a single chip is relatively high, but for the whole machine, the power consumption will be reduced by more than 30%. When used in satellite systems, the power consumption advantage is obvious, and the size advantage is also obvious. ADC/DAC transmits data through parallel buses inside the FPGA, and the analog-to-digital converter and digital RF memory are integrated on the same system level chip, so high-speed parallel processing can be achieved without the need for precise connection on the circuit board, reducing the external wiring of the PCB board and reducing the area by more than 30%. As shown in FIG. 11, this embodiment provides a schematic diagram of the internal wiring of an FPGA, in which when using ZU65DR as a transceiver device, the wiring between the transceiver and ADC/DAC can be reduced. The next generation RFSoC may eventually be installed in the next-generation product VERSAL, which combines hardware and programmable software and can be used for any application. Compared to existing digital RF memory, VERSAL has achieved simplification in research and development. As shown in FIG. 12, this embodiment provides a schematic diagram of the internal integration of RFSoC. The RFSoC provides a complete hard core solution and interface with soft cores. AD9371 requires software modulation and demodulation as well as coding and decoding development within FPGA. The communication algorithm development of RFSoC combining hard and soft cores can effectively accelerate the development progress.

In some embodiments, the conventional receiver, such as satellite transmitter receiver with three-level super-heterodyne mode, needs multiple VCOs or PLLs for conventional receivers, and the signal needs multi-stage filtering and amplification to reach the baseband.

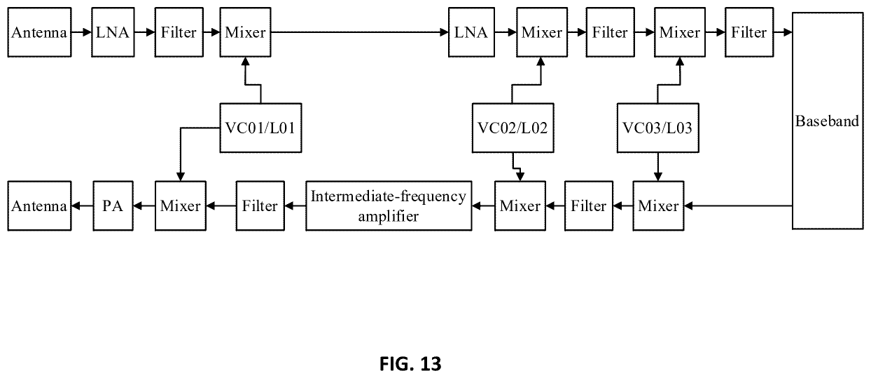

This invisibly reduces the signal-to-noise ratio of the signal, increases the noise figure, and increases power consumption. It is risky to use it on low orbit satellites, but it can also be used. As shown in FIG. 13, this embodiment provides a radio frequency communication system with three-level super-heterodyne mode, where the first link includes an antenna, two LNAs, three filters, three mixers, and the second link includes an antenna, a PA, two filters, three mixers, and an intermediate frequency amplifier; and also includes three VCOs/LOs.

The radio frequency communication system provided by this embodiment has a high rate and a large bandwidth, which can meet the demand for the use of Ku-band in LEO; the chip (AD9371/ZU65DR) has a high degree of integration, a small size, and a low power consumption that can adapt to the small size of LEO satellites.

In some embodiments, the radio frequency communication system of this embodiment can also be configured to design into a satellite, or be integrated into a satellite for signal transmitting and receiving. The structure of the radio frequency communication system can be designed based on the structure of a microsatellite, including the design of the shape of the satellite, the design of the layout of the entire satellite, and the design of the main load-bearing structure. On the basis of structural design, finite element modeling of the entire satellite can also be carried out in ANSYS Workbench software. Based on the characteristics and layout of the satellite structure, the structure has been simplified and simulated accordingly. Based on the load and boundary conditions provided by the transportation department, static analysis, modal analysis, sine response analysis, and random vibration response analysis were conducted on the entire satellite using ANSYS Workbench software, and the results of each calculation were analyzed and discussed. Finally, based on the mechanical analysis data, the mechanical properties of the designed satellite structure and main load-bearing structure are analyzed, and the final conclusion is drawn.

Due to the fact that the thermal control system of artificial satellites is a system that controls the internal and external heat of the satellite during its orbital flight to achieve the required temperature range. When a satellite is in orbit, it will encounter two environments: high temperature and low temperature. The sun is a great source of heat. At altitudes of several hundred to several kilometers, very thin gases cannot block the sun's radiation, and there is no conduction or convection heat dissipation. If the sun directly shines on the surface of the satellite without protection, the temperature of the satellite will quickly rise. When the satellite flies to the other side of the Earth, it enters the shadow zone and cannot receive the heat of the sun, causing the temperature to quickly decrease. Satellites operate at alternating temperatures ranging from 100 degrees Celsius to −100 degrees Celsius. On the other hand, the reflection of sunlight from the Earth and the low-temperature infrared radiation also affect the surface of satellites. At the same time, when the instruments and equipment inside the satellite are working, they also need to dissipate heat outward. Therefore, the structure of radio frequency communication systems can also be designed based on thermal design in satellite systems. General electronic instruments and equipment will malfunction if they work in an environment above 50 degrees Celsius for a long time, while some devices such as chemical batteries have low efficiency below zero degrees Celsius. Therefore, despite the drastic temperature changes in the external environment, a certain temperature range must be maintained inside the satellite to ensure the normal operation of the instruments and equipment inside the satellite. The thermal control system can ensure that the temperature inside the satellite remains within a certain range of variation. The temperature inside a satellite is generally maintained within the range from 5 to 45 degrees Celsius, and some parts are only allowed to have a variation range from 1 to 2 degrees Celsius at a constant temperature.

Optionally, when the signal strength is sufficient, the power consumption of passive antennas is lower than that of active antennas. In use cases that require higher sensitivity, using active antennas may not increase the gain of the RF path. In such cases, active antennas with external LNA control can turn off the LNA (when not using satellite signals) instead of always keeping it on. By adjusting the RF path gain according to environmental conditions, LNA with internal power consumption settings can reduce the power consumption required to provide necessary sensitivity and rate. Therefore, the specific structure of the RF communication system can be designed according to actual needs, such as whether to install active antennas with external LNA control and whether to use LNAs with internal power consumption settings.

In addition, designers of tracking solutions can use a complete set of design strategies to optimize device power consumption. Due to the fact that each decision not only affects power consumption, but also impacts the performance, size, and cost of tracking solutions, solution designers must carefully weigh the pros and cons of each strategy to find the lowest power configuration that can provide the required tracking performance.

Optionally, low-power components (LNAs, crystals, real-time clocks) can be selected for the radio frequency communication system that will marginally improve the total power consumption of the satellite receiver during operation.

Optionally, a power outage can cause the satellite receiver to lose its positioning and all downloaded time and satellite orbit data. Therefore, when the power is restored, the satellite receiver will be forced to perform a complete cold start. By storing such data in backup RAM, satellite receivers with backup batteries can recover faster from power outages, thereby saving power. When the position update cycle is longer than two hours (roughly corresponding to the effective time of ephemeris data), the backup battery becomes redundant, so the backup battery can be removed to reduce power consumption. For example, the positioning and all downloaded time and satellite orbit data can be stored in the backup RAM of the radio frequency communication system, and a backup battery can be configured for quick recovery from power outages.

In some embodiments, although crystal oscillators can output stable frequency signals with low power consumption, temperature fluctuations can affect their frequency, thereby affecting the sensitivity and transmission/reception rate of satellite receivers, and thus increasing power consumption. Temperature controlled crystal oscillator (TCXO) can solve the problem of temperature sensitivity and reduce positioning power consumption, but it will consume slightly more power during continuous operation. The choice of crystal oscillator depends on the required positioning performance and the specific component combination used. The use cases that rely on small antenna design or are expected to operate in weak signal environments can improve the sensitivity of satellite receivers by selecting TCXOs. In practical applications, the crystal oscillator required for radio frequency communication systems can be selected according to specific needs.

Based on the same inventive concept, embodiments of the present disclosure further provide a radio frequency communication apparatus, due to the similarity in problem-solving principles between this device and the system, the implementation of this device can be referred to in the implementation of the system, and repetition will not be repeated here.

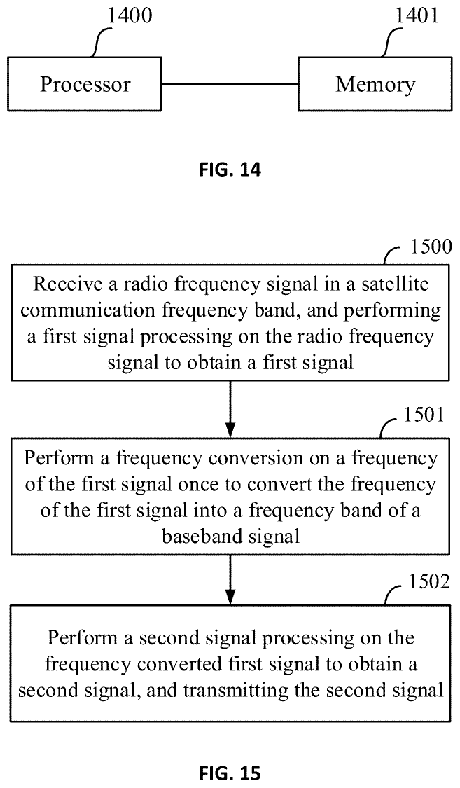

As shown in FIG. 14, the apparatus includes a processor 1400 and a memory 1401, where the memory 1401 stores program codes, and the program codes, when executed by the processer 1400, cause the processor 1400 to perform the process of:
receiving a radio frequency signal in a satellite communication frequency band, and performing a first signal processing on the radio frequency signal to obtain a first signal;
performing a frequency conversion on a frequency of the first signal once to convert the frequency of the first signal into a frequency band of a baseband signal; and
performing a second signal processing on the frequency converted first signal to obtain a second signal, and transmitting the second signal.

In some embodiments, the processor 1400 is further configured to perform:
receiving the radio frequency signal using a first antenna; and
performing the first signal processing on the radio frequency signal using a first radio frequency switch, a low noise power amplifier, a first mixer and a first filter to obtain the first signal.

In some embodiments, the first filter includes a first sub-filter, a second sub-filter and a third sub-filter, and the low noise power amplifier includes a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, the processor 1400 is further configured to perform:
performing the second signal processing on the frequency converted first signal using a second radio frequency switch, a power amplifier, a second mixer and a second filter to obtain the second signal; and
transmitting the second signal using a second antenna.

In some embodiments, the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the first radio frequency switch and the second radio frequency switch are arranged as a circulator.

In some embodiments, the processor 1400 is further configured to perform:
performing a frequency mixing processing on the first signal;
performing an analog-to-digital conversion processing on a frequency mixed first signal;
performing an orthogonal modulation calibration processing on an analog-to-digital conversed first signal; and
performing a filtering processing on a calibrated first signal to obtain the frequency converted first signal.

In some embodiments, the processor 1400 is further configured to perform:
receiving the baseband signal;
performing a filtering processing on the baseband signal;
performing an analog-to-digital conversion processing on a filtered baseband signal, and
performing a frequency mixing processing on an analog-to-digital conversed baseband signal to obtain a first radio frequency signal.

In some embodiments, the processor 1400 is further configured to perform:
performing an analog-to-digital conversion processing on the first signal;
performing a threshold detection processing on an analog-to-digital conversed first signal;
performing an orthogonal modulation calibration processing on a threshold detected first signal;
performing a frequency mixing processing on a calibrated first signal; and
performing a demodulation processing on a frequency mixed first signal to obtain the frequency converted first signal.

In some embodiments, the processor 1400 is further configured to perform:
receiving the baseband signal;
performing a modulate processing on the baseband signal;
performing a frequency mixing processing on a modulated baseband signal;
performing an orthogonal modulation calibration processing on a frequency mixed baseband signal; and
performing an analog-to-digital conversion processing on a calibrated baseband signal to obtain a second radio frequency signal.

Based on the same inventive concept, embodiments of the present disclosure further provide a radio frequency communication method, due to the similarity in problem-solving principles between this method and the system, the implementation of this device can be referred to in the implementation of the system, and repetition will not be repeated here.

As shown in FIG. 15, the method is implemented as follows.

Step 1500: receive a radio frequency signal in a satellite communication frequency band, and performing a first signal processing on the radio frequency signal to obtain a first signal.

Step 1501, perform a frequency conversion on a frequency of the first signal once to convert the frequency of the first signal into a frequency band of a baseband signal.

Step 1502: perform a second signal processing on the frequency converted first signal to obtain a second signal, and transmitting the second signal.

In some embodiments, the receiving a radio frequency signal in a satellite communication frequency band, and performing a first signal processing on the radio frequency signal to obtain a first signal, includes:
receiving the radio frequency signal using a first antenna; and
performing the first signal processing on the radio frequency signal using a first radio frequency switch, a low noise power amplifier, a first mixer and a first filter to obtain the first signal.

In some embodiments, the first filter includes a first sub-filter, a second sub-filter and a third sub-filter, and the low noise power amplifier includes a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, the performing a second signal processing on the frequency converted first signal to obtain a second signal, includes:
performing the second signal processing on the frequency converted first signal using a second radio frequency switch, a power amplifier, a second mixer and a second filter to obtain the second signal; and
transmitting the second signal using a second antenna.

In some embodiments, the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the method further includes: arranging the first radio frequency switch and the second radio frequency switch as a circulator.

In some embodiments, the performing a first signal processing on the radio frequency signal, includes:
performing a frequency mixing processing on the first signal;
performing an analog-to-digital conversion processing on a frequency mixed first signal;
performing an orthogonal modulation calibration processing on an analog-to-digital conversed first signal; and
performing a filtering processing on a calibrated first signal to obtain the frequency converted first signal.

In some embodiments, the method further includes:
receiving the baseband signal;
performing a filtering processing on the baseband signal;
performing an analog-to-digital conversion processing on a filtered baseband signal, and
performing a frequency mixing processing on an analog-to-digital conversed baseband signal to obtain a first radio frequency signal.

In some embodiments, the performing a first signal processing on the radio frequency signal, includes:
performing an analog-to-digital conversion processing on the first signal;
performing a threshold detection processing on an analog-to-digital conversed first signal;
performing an orthogonal modulation calibration processing on a threshold detected first signal;
performing a frequency mixing processing on a calibrated first signal; and
performing a demodulation processing on a frequency mixed first signal to obtain the frequency converted first signal.

In some embodiments, the method further includes:
receiving the baseband signal;
performing a modulate processing on the baseband signal;
performing a frequency mixing processing on a modulated baseband signal;
performing an orthogonal modulation calibration processing on a frequency mixed baseband signal; and
performing an analog-to-digital conversion processing on a calibrated baseband signal to obtain a second radio frequency signal.

Based on the same inventive concept, embodiments of the present disclosure further provide a radio frequency communication apparatus, due to the similarity in problem-solving principles between this apparatus and the system, the implementation of this device can be referred to in the implementation of the system, and repetition will not be repeated here.

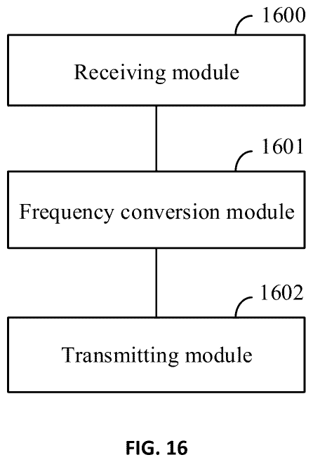

As shown in FIG. 16, the apparatus includes:
a receiving module 1600, configured to receive a radio frequency signal in a satellite communication frequency band, and performing a first signal processing on the radio frequency signal to obtain a first signal;
a frequency conversion module 1601, configured to perform a frequency conversion on a frequency of the first signal once to convert the frequency of the first signal into a frequency band of a baseband signal; and
a transmitting module 1602, configured to perform a second signal processing on the frequency converted first signal to obtain a second signal, and transmitting the second signal.

In some embodiments, the receiving module 1600 is further configured to:
receive the radio frequency signal using a first antenna; and
perform the first signal processing on the radio frequency signal using a first radio frequency switch, a low noise power amplifier, a first mixer and a first filter to obtain the first signal.

In some embodiments, the first filter includes a first sub-filter, a second sub-filter and a third sub-filter, and the low noise power amplifier includes a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

In some embodiments, the transmitting module 1602 is further configured to:
perform the second signal processing on the frequency converted first signal using a second radio frequency switch, a power amplifier, a second mixer and a second filter to obtain the second signal; and
transmit the second signal using a second antenna.

In some embodiments, the second filter includes a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

In some embodiments, the apparatus further includes an arranging module configured to arrange the first radio frequency switch and the second radio frequency switch as a circulator.

In some embodiments, the receiving module 1600 is further configured to:
perform a frequency mixing processing on the first signal;
perform an analog-to-digital conversion processing on a frequency mixed first signal;
perform an orthogonal modulation calibration processing on an analog-to-digital conversed first signal; and
perform a filtering processing on a calibrated first signal to obtain the frequency converted first signal.

In some embodiments, the receiving module 1600 is further configured to:
receive the baseband signal;
perform a filtering processing on the baseband signal;
perform an analog-to-digital conversion processing on a filtered baseband signal, and
perform a frequency mixing processing on an analog-to-digital conversed baseband signal to obtain a first radio frequency signal.

In some embodiments, the receiving module 1600 is further configured to:
perform an analog-to-digital conversion processing on the first signal;
perform a threshold detection processing on an analog-to-digital conversed first signal;
perform an orthogonal modulation calibration processing on a threshold detected first signal;
perform a frequency mixing processing on a calibrated first signal; and
perform a demodulation processing on a frequency mixed first signal to obtain the frequency converted first signal.

In some embodiments, the receiving module 1600 is further configured to:
receive the baseband signal;
perform a modulate processing on the baseband signal;
perform a frequency mixing processing on a modulated baseband signal;
perform an orthogonal modulation calibration processing on a frequency mixed baseband signal; and
perform an analog-to-digital conversion processing on a calibrated baseband signal to obtain a second radio frequency signal.

Based on the same inventive concept, embodiments of the present disclosure provide a computer storage medium storing a computer program thereon, where the program, when executed by a processor, implements the radio frequency communication method as discussed above. Due to the similarity in problem-solving principles between the computer storage medium and the method, the implementation of the computer storage medium can be referred to in the implementation of the method, and repetition will not be repeated here.

In some embodiments, the computer storage media can include: Universal Serial Bus Flash Drive (USB), mobile hard disk, Read-Only Memory (ROM), Random Access Memory (RAM), Disk or CD-ROM and other storage media that can store program code.

Based on the same inventive concept, embodiments of the present disclosure further provide a computer program product, the computer program product includes: computer program code that, when executed on a computer, causes the computer to perform any of the radio frequency communication methods discussed above. Due to the similarity between the problem-solving principle of the aforementioned computer program product and the radio frequency communication method, the implementation of the aforementioned computer program product can be referred to in the implementation of the method, and the repetition will not be repeated.

Computer program products can use any combination of one or more readable media. The readable medium can be a readable signal medium or a readable storage medium.

Readable storage media can be, for example but not limited to, systems, devices, or devices of electricity, magnetism, light, electromagnetism, infrared, or semiconductors, or any combination of the above. More specific examples of readable storage media (non-exhaustive list) include: electrical connections with one or more wires, portable disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof.

It should be appreciated by those skilled in the art that embodiments of the present disclosure may be provided as methods, systems, or computer program products. Accordingly, the present disclosure may take the form of a fully hardware embodiment, a fully software embodiment, or an embodiment that combines software and hardware aspects. Further, the present disclosure may take the form of a computer program product implemented on one or more computer-usable storage media (including, but not limited to, disk memory and optical memory, etc.) containing computer-usable program code.

The present disclosure is described with reference to the flowchart and/or block diagram of the method, device (system), and computer program product according to the embodiments of this disclosure. It should be understood that each process and/or block in the flowchart and/or block diagram, as well as the combination of processes and/or blocks in the flowchart and/or block diagram, can be implemented by computer program instructions. These computer program instructions can be provided to a processor of a general-purpose computer, specialized computer, embedded processor, or other programmable data processing device to generate a machine, such that the instructions executed by the processor of the computer or other programmable data processing device generate a device for implementing the functions specified in one or more processes in the flowchart and/or one or more boxes in the block diagram.

These computer program instructions can also be stored in computer-readable memory that can guide a computer or other programmable data processing device to operate in a specific manner, such that the instructions stored in the computer-readable memory generate a manufactured product including the instruction device, which implements the functions specified in one or more processes of a flowchart and/or one or more boxes of a block diagram.

These computer program instructions can also be loaded onto a computer or other programmable data processing device, enabling a series of operational steps to be executed on the computer or other programmable device to generate computer implemented processing. The instructions executed on the computer or other programmable device provide steps for implementing the functions specified in one or more processes in the flowchart and/or one or more boxes in the block diagram.

Evidently those skilled in the art can make various modifications and variations to the present disclosure without departing from the spirit and scope of the present disclosure. Thus the present disclosure is also intended to encompass these modifications and variations therein as long as these modifications and variations to the present disclosure come into the scope of the claims of the present disclosure and their equivalents.

1. A radio frequency communication system, comprising: a first link, a second link, and a transceiver device, wherein:
the first link is configured to receive a radio frequency signal in a satellite communication frequency band, perform a first signal processing on the radio frequency signal to obtain a first signal, and transmit the first signal to the transceiver device;
the transceiver device is configured to perform a frequency conversion on a frequency of the first signal once to convert the frequency of the first signal into a frequency band of a baseband signal, and transmit a frequency converted first signal to the second link; and
the second link is configured to perform a second signal processing on the frequency converted first signal to obtain a second signal, and transmit the second signal.

2. The system according to claim 1, wherein the first link comprises a first antenna, a first radio frequency switch, a low noise power amplifier, a first mixer and a first filter;
wherein the first link is further configured to:
receive the radio frequency signal using the first antenna; and
perform the first signal processing on the radio frequency signal using the first radio frequency switch, the low noise power amplifier, the first mixer and the first filter to obtain the first signal.

3. The system according to claim 2, wherein the first filter comprises a first sub-filter, a second sub-filter and a third sub-filter, and the low noise power amplifier comprises a first low noise power amplifier and a second low noise power amplifier;
the first sub-filter is connected with the first radio frequency switch and the first low noise power amplifier, the second sub-filter is connected with the first low noise power amplifier and the first mixer, and the third sub-filter is connected with the second low noise power amplifier and the transceiver device.

4. The system according to claim 1, wherein the second link comprises a second antenna, a second radio frequency switch, a power amplifier, a second mixer, and a second filter;
wherein the second link is further configured to:
perform the second signal processing on the frequency converted first signal using the second radio frequency switch, the power amplifier, the second mixer and the second filter to obtain the second signal; and
transmit the second signal using the second antenna.

5. The system according to claim 4, wherein the second filter comprises a fourth sub-filter and a fifth sub-filter; the fourth sub-filter is connected with the transceiver device and the second mixer, and the fifth sub-filter is connected with the second mixer and the power amplifier; or
the second radio frequency switch is connected with the power amplifier and the second antenna.

6. The system according to claim 1, wherein the first link and the second link are connected with the same radio frequency switch or the same circulator for compatibility with time division duplex mode.

7. The system according to claim 1, wherein the first link comprises a first radio frequency switch; and the second link comprises a second radio frequency switch;
wherein the first radio frequency switch and the second radio frequency switch are arranged as a circulator.

8. The system according to claim 1, wherein the transceiver device is further configured to:
perform a frequency mixing processing on the first signal to obtain a frequency mixed first signal;
perform an analog-to-digital conversion processing on the frequency mixed first signal to obtain an analog-to-digital conversed first signal;
perform an orthogonal modulation calibration processing on the analog-to-digital conversed first signal to obtain a calibrated first signal; and
perform a filtering processing on the calibrated first signal to obtain the frequency converted first signal.

9. The system according to claim 8, wherein the transceiver device is further configured to:
receive the baseband signal;
perform a filtering processing on the baseband signal to obtain a filtered baseband signal;
perform an analog-to-digital conversion processing on the filtered baseband signal to obtain an analog-to-digital conversed baseband signal, and
perform a frequency mixing processing on the analog-to-digital conversed baseband signal to obtain a first radio frequency signal.

10. The system according to claim 1, wherein the transceiver device is further configured to:
perform an analog-to-digital conversion processing on the first signal to obtain an analog-to-digital conversed first signal;
perform a threshold detection processing on the analog-to-digital conversed first signal to obtain a threshold detected first signal;
perform an orthogonal modulation calibration processing on the threshold detected first signal to obtain a calibrated first signal;
perform a frequency mixing processing on the calibrated first signal to obtain a frequency mixed first signal; and
perform a demodulation processing on the frequency mixed first signal to obtain the frequency converted first signal.

11. The system according to claim 10, wherein the transceiver device is further configured to:
receive the baseband signal;
perform a modulate processing on the baseband signal to obtain a modulated baseband signal;
perform a frequency mixing processing on the modulated baseband signal to obtain a frequency mixed baseband signal;
perform an orthogonal modulation calibration processing on the frequency mixed baseband signal to obtain a calibrated baseband signal; and
perform an analog-to-digital conversion processing on the calibrated baseband signal to obtain a second radio frequency signal.

12. A radio frequency communication apparatus, comprising a processor and a memory, wherein the memory stores program codes, and the program codes, when executed by the processer, cause the processor to perform the process of:
receiving a radio frequency signal in a satellite communication frequency band, and performing a first signal processing on the radio frequency signal to obtain a first signal;
performing a frequency conversion on a frequency of the first signal once to convert the frequency of the first signal into a frequency band of a baseband signal; and
performing a second signal processing on the frequency converted first signal to obtain a second signal, and transmitting the second signal.

13. The apparatus according to claim 12, wherein the processor is further configured to perform:
receiving the radio frequency signal using a first antenna; and
performing the first signal processing on the radio frequency signal using a first radio frequency switch, a low noise power amplifier, a first mixer and a first filter to obtain the first signal.

14. The apparatus according to claim 12, wherein the processor is further configured to perform:
performing the second signal processing on the frequency converted first signal using a second radio frequency switch, a power amplifier, a second mixer and a second filter to obtain the second signal; and
transmitting the second signal using a second antenna.

15. The apparatus according to claim 12, wherein the processor is further configured to perform:
performing a frequency mixing processing on the first signal to obtain a frequency mixed first signal;
performing an analog-to-digital conversion processing on the frequency mixed first signal to obtain an analog-to-digital conversed first signal;
performing an orthogonal modulation calibration processing on the analog-to-digital conversed first signal to obtain a calibrated first signal; and
performing a filtering processing on the calibrated first signal to obtain the frequency converted first signal.

16. The apparatus according to claim 12, wherein the processor is further configured to perform:
performing an analog-to-digital conversion processing on the first signal to obtain an analog-to-digital conversed first signal;
performing a threshold detection processing on the analog-to-digital conversed first signal to obtain a threshold detected first signal;
performing an orthogonal modulation calibration processing on the threshold detected first signal to obtain a calibrated first signal;
performing a frequency mixing processing on the calibrated first signal to obtain a frequency mixed first signal; and
performing a demodulation processing on the frequency mixed first signal to obtain the frequency converted first signal.

17. A radio frequency communication method, comprising:
receiving a radio frequency signal in a satellite communication frequency band, and performing a first signal processing on the radio frequency signal to obtain a first signal;
performing a frequency conversion on a frequency of the first signal once to convert the frequency of the first signal into a frequency band of a baseband signal; and
performing a second signal processing on the frequency converted first signal to obtain a second signal, and transmitting the second signal.

18. A computer storage medium storing a computer program thereon, wherein the program, when executed by a processor, implements the method according to claim 17.

19. The apparatus according to claim 15, wherein the processor is further configured to perform:
receiving the baseband signal;
performing a filtering processing on the baseband signal to obtain a filtered baseband signal;
performing an analog-to-digital conversion processing on the filtered baseband signal to obtain an analog-to-digital conversed baseband signal, and
performing a frequency mixing processing on the analog-to-digital conversed baseband signal to obtain a first radio frequency signal.

20. The apparatus according to claim 16, wherein the processor is further configured to perform:
receiving the baseband signal;
performing a modulate processing on the baseband signal to obtain a modulated baseband signal;
performing a frequency mixing processing on the modulated baseband signal to obtain a frequency mixed baseband signal;
performing an orthogonal modulation calibration processing on the frequency mixed baseband signal to obtain a calibrated baseband signal; and
performing an analog-to-digital conversion processing on the calibrated baseband signal to obtain a second radio frequency signal.
